(19) United States
(12) Patent Application Publication
(10) Pub. No.: US 2010/0200558 A1
(43) Pub. Date: Aug. 12, 2010

(54) ELECTRICAL HEATING BLANKET

(76) Inventors: Ying-Hsiung LIU, Taipei (TW); Wen-Hung Wang, Chang-Hua Hsien (TW)

Correspondence Address: BIRCH STEWART KOLASCH & BIRCH, PO BOX 747, FALLS CHURCH, VA, 22040-0747, US

(21) Appl. No.: 12/369,927

(22) Filed: Feb. 12, 2009

(51) Int. Cl. H05B 3/00

(52) U.S. Cl. 219/212

(57) ABSTRACT

An electrical heating blanket includes an electrical heating layer and a sheath layer, wherein the electrical heating layer includes a fabric incorporating with a plurality of woven carbon fibers, and power wires are electrically connected in parallel with each of the carbon fibers. The sheath layer encapsulates the electrical heating layer. The electrical heating blanket may be operable with a DC voltage of about 10V to 20V supplied through the power wires to cause the carbon fibers to produce heat without emitting electromagnetic radiations. This structure may be suitable to fabricate clothes, belts or like products that can protect the human's health.

### BACKGROUND OF THE INVENTION

1. Field of the Invention

The present invention generally relates to an electrical heating blanket used for covering a user's body and adapted to produce heat.

2. The Prior Arts

People may use an electrical heating blanket to keep warm at low temperatures during cold seasons. Conventionally, an electrical heating blanket includes metallic heating wires adapted to produce heat. However, when powered on, the metallic wires of the conventional electrical heating blanket produce strong electromagnetic radiations that may have undesirable effects on the human's health. Moreover, after a period of use, the electrical heating blanket may absorb humidity from the user's body or surrounding air, which may cause short-circuits between the metallic wires. This problem may be exacerbated when droplets of water are inadvertently sprayed on the blanket, causing current leakage and electric shock. Furthermore, the metallic wires used in the conventional electrical heating blanket are usually made of copper, which increases the weight of the blanket and renders the user less comfortable.

### SUMMARY OF THE INVENTION

A primary objective of the present invention is to provide an electrical heating blanket that can overcome the foregoing issues in relation to the adverse electromagnetic radiations, easy short-circuits and electric shock, and uncomfortable in use due to heavyweight.

In order to achieve the above-mentioned objective, an electrical heating blanket according to the present invention comprises thermally conductive carbon fibers incorporated in a fabric, wherein the carbon fibers are connected with power wires. When powered on, the carbon fibers produce heat. The use of carbon fibers renders the electrical heating blanket lightweight, does not produce electromagnetic radiations when an electric current flows therethrough, and does not cause electrical leakage and electric shock due to ambient humidity. As a result, the electrical heating blanket or similar products such as clothes, belts, or the like, are therefore lightweight and more comfortable in use.

According to one embodiment of the present invention, the electrical heating blanket comprises an electrical heating layer and a sheath layer, wherein the electrical heating layer includes a fabric incorporating with a plurality of woven carbon fibers, and power wires electrically connected in parallel with each of the carbon fibers. The sheath layer encapsulates the electrical heating layer. The electrical heating blanket may be operable with a DC voltage of about 10V to 20V supplied through the power wires to cause the carbon fibers to produce heat.

Based on the use of a relatively low power voltage, each carbon fiber according to one embodiment of the present invention is woven to form an approximately M-shape, wherein each M-shaped carbon fiber has two ends electrically connected in parallel with an anode power wire and a cathode power wire, respectively. The power wires may be connected with a power adapter that is coupled to an electrical plug. When the electrical plug is plugged into a power socket, the power adapter turns the AC current into a DC current that then flows through the carbon fibers to produce heat. Alternatively, the carbon fibers may also be supplied with a DC power from a battery.

In one embodiment, electrically conductive rivets may also be used to secure the power wires with the carbon fibers in the fabric by a pressing action.

### BRIEF DESCRIPTION OF THE DRAWINGS

The invention, together with its objectives and the advantages thereof may be best understood by reference to the following description taken in conjunction with the accompanying drawings, in which:

FIG. 1 is a perspective view of an electrical heating blanket according to an embodiment of the present invention;

FIG. 2 is a planar view illustrating the structure of the electrical heating blanket according to an embodiment of the present invention; and

FIG. 3 is schematic view illustrating the use of rivets to secure power wires with carbon fibers in an electrical heating blanket according to an embodiment of the present invention.

### DETAILED DESCRIPTION OF THE PREFERRED EMBODIMENTS

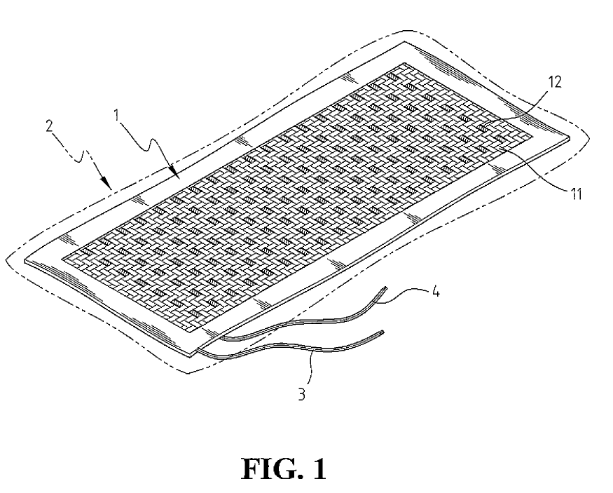

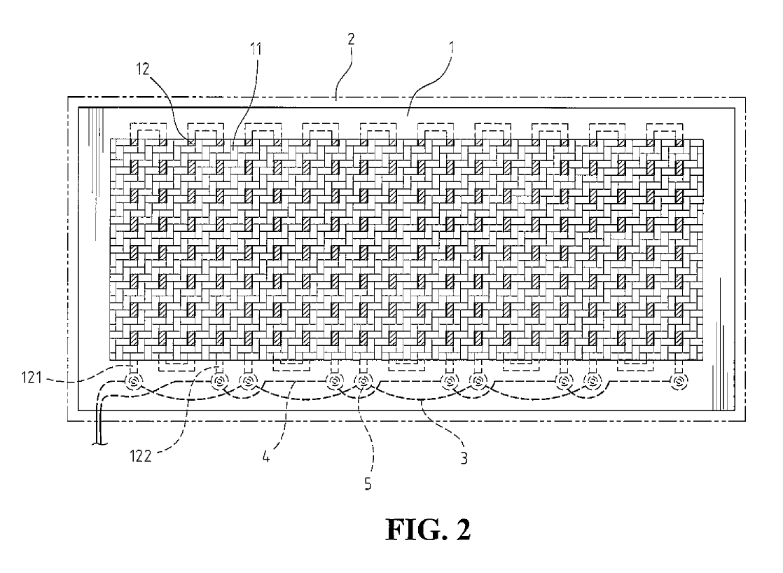

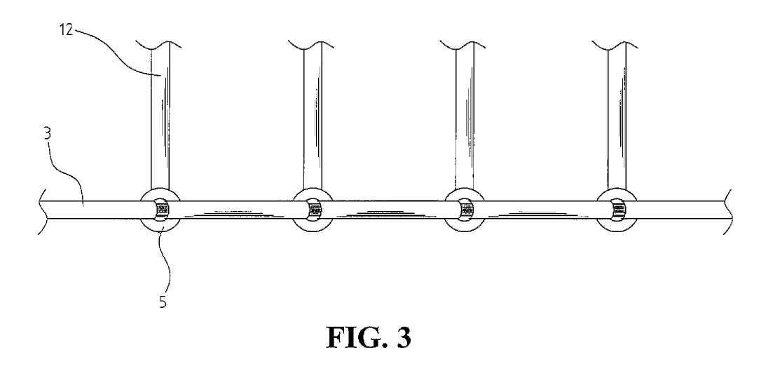

As shown in FIGS. 1 and 2, an electrical heating blanket according to an embodiment of the present invention comprises an electrical heater layer 1 and a sheath layer 2. The electrical heater layer 1 is placed inside the sheath layer 2. The electrical heater layer 1 includes a fabric 11 made of cotton, feather, nylon or any suitable bedclothes materials. When the fabric 11 is fabricated, a plurality of non-metallic woven carbon fibers 12 are incorporated into the fabric 11, so that the carbon fibers 12 form a part of the structure of the fabric 11. In one preferred embodiment, each of the carbon fibers 12 is woven to form an approximately M-shape (as shown in FIG. 2). One side of the electrical heater layer 1 is connected with an anode power wire 3 and a cathode power wire 4. More specifically, a first end 121 of each of the M-shaped carbon fibers 12 is electrically connected with the anode power wire 3, and a second end 122 of the M-shaped carbon fiber 12 is electrically connected with the cathode power wire 4. The anode power wire 3 and the cathode power wire 4 pass through the fabric 11 to externally connect with a power source, so that the carbon fibers 12 form a parallel circuit. FIG. 3 illustrates one embodiment for electrically connecting the carbon fibers 12 with the power wires. As shown, electrical conductive rivets 5 may be used to securely fix the anode power wire 3 and/or the cathode power wire 4 to the fabric 11 by a pressing action.

The sheath layer 2 is made of a material similar to conventional bedclothes materials used for encapsulating the electrical heater layer 1. After the sheath layer 2 encapsulates the electrical heater layer 1, the power wires 3 are passed through the sheath layer 2.

In the aforementioned structure, the anode power wire 3 and the cathode power wire 4 may be electrically connected with a power adapter (not shown) that is coupled to an electrical plug. When the electrical plug is plugged into a power socket, the power adapter turns the AC current into a DC current that then flows through the carbon fibers 12 to produce heat. Alternatively, the carbon fibers 12 may also receive a DC power from a battery placed in a battery case. In one embodiment, a DC voltage of about 10V to 20V may be supplied through the power wires to cause the carbon fibers to produce heat, without generating electromagnetic radiations. The electrical heating blanket thereby fabricated is lightweight and comfortable in use, and is protected against electrical leakage or electric shock caused by humidity or physical contacts with water.

While the foregoing is directed to embodiments of the present invention, other and further embodiments of the invention may be devised without departing from the basic scope thereof, and the scope thereof is determined by the claims that follow.

What is claimed is:

1. An electrical heating blanket, comprising:
an electrical heating layer including a fabric incorporating with a plurality of woven carbon fibers, wherein the electrical heating layer has power wires electrically connected in parallel with each of the carbon fibers; and
a sheath layer encapsulating the electrical heating layer, wherein the power wires pass through the sheath layer.

2. The electrical heating blanket according to claim 1, wherein each of the carbon fibers is woven to form an approximately M-shape.

3. The electrical heating blanket according to claim 1, wherein the power wires are secured with the carbon fibers through electrically conductive rivets.

4. The electrical heating blanket according to claim 2, wherein the power wires are secured with the carbon fibers through electrically conductive rivets.
